(19) United States
(12) Patent Application Publication
(10) Pub. No.: US 2025/0272826 A1
(43) Pub. Date: Aug. 28, 2025

(54) SIMILARITY MAP-BASED OUTLIERS DETECTION

(71) Applicant: AI QUALISENSE 2021 LTD, Tel Aviv-Yafo (IL)

(72) Inventor: Karina Odinaev, Tel Aviv (IL)

(73) Assignee: AI QUALISENSE 2021 LTD, Tel Aviv-Yafo (IL)

(21) Appl. No.: 18/858,288

(22) PCT Filed: Apr. 18, 2023
(86) PCT No.: PCT/IB2023/053975

§ 371 Date: Oct. 18, 2024

Related U.S. Application Data
(60) Provisional application No. 63/363,175, filed on Apr. 18, 2022.

(51) Int. Cl. G06T 7/00; G06T 7/11; G06V 10/74

(52) U.S. Cl. CPC G06T 7/001; G06T 7/11; G06V 10/761; G06T 2207/30164

(57) ABSTRACT

A method for detecting defects in manufactured items. The method may include obtaining an image of an evaluated manufactured item; finding one or more sets of comparable patches. The finding is based on a similarity mapping that is generated based on inter-reference image similarities between patches of reference images; comparing comparable patches of each set to each other to provide one or more set comparison results; and determining an evaluated manufactured item parameter based on at least some of the one or more set comparison results.

### BACKGROUND OF THE INVENTION

Defect detection is a process that involve acquiring images of evaluated objects and processing the images to detect defects.

A common method for defect detection include comparing an image of an evaluated object to an image of a reference object. The comparison requires to align the inspected object to the reference object. The alignment may be time and resource consuming—especially when the objects is not flat—and especially when the object is curved.

There is a growing need to provide a cost-effective defect detection process.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 illustrates an example of a method;

FIG. 2 illustrates an example of a method;

FIG. 3 illustrates an example of images and a similarity mapping;

FIG. 4 illustrates an example of images and a similarity mapping; and

FIG. 5 illustrates an example of a computerized system and a manufacturing process tool.

### DETAILED DESCRIPTION OF THE DRAWINGS

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

Because the illustrated embodiments of the present invention may for the most part, be implemented using electronic components and circuits known to those skilled in the art, details will not be explained in any greater extent than that considered necessary as illustrated above, for the understanding and appreciation of the underlying concepts of the present invention and in order not to obfuscate or distract from the teachings of the present invention.

Any reference in the specification to a method should be applied mutatis mutandis to a system capable of executing the method and should be applied mutatis mutandis to a non-transitory computer readable medium that stores instructions that once executed by a computer result in the execution of the method.

Any reference in the specification to a system should be applied mutatis mutandis to a method that may be executed by the system and should be applied mutatis mutandis to a non-transitory computer readable medium that stores instructions that may be executed by the system.

Any reference in the specification to a non-transitory computer readable medium should be applied mutatis mutandis to a system capable of executing the instructions stored in the non-transitory computer readable medium and should be applied mutatis mutandis to method that may be executed by a computer that reads the instructions stored in the non-transitory computer readable medium.

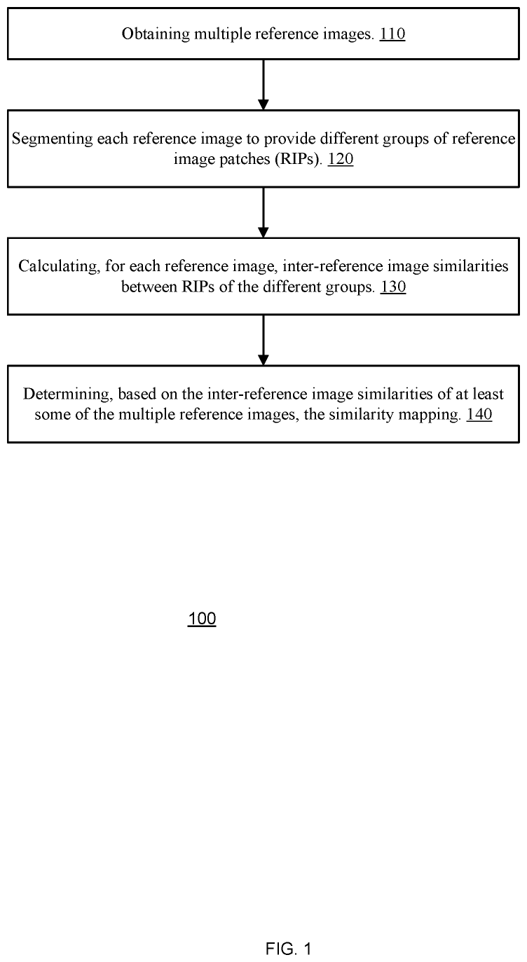

FIG. 1 illustrates method 100 for calculating a similarity mapping. The similarity mapping will be used for detecting defects.

Method 100 may start by step 110 of obtaining multiple reference images.

The reference images may be images that are labeled, images that are not labeled, may be images of manufactured items that are expected to be non-defective, may be expected to be mostly non-defective (for example images of manufactured items that are manufactured using a manufacturing process of known statistical distribution-for example-having most of the manufactured items be non-defective, and the like.

When the reference images are unaligned—the method may not require to align (during the execution of method 200) the image of an evaluated manufactured item.

Step 110 may be followed by step 120 of segmenting each reference image to provide different groups of reference image patches (RIPs).

Evaluated RIPs of the different groups of evaluated RIPs differ from each other by one or more RIP attribute. Using groups of RIPs that differ from each other increases the chance to find comparable RIPs—especially when step 120 is executed without prior knowledge of the expected comparable RIPs.

The different groups of RIPs may differ from each other by at least one out of size, shape, overlap between adjacent RIPs, or any other manner.

Step 120 may be followed by step 130 of calculating, for each reference image, inter-reference image similarities between RIPs of the different groups.

The calculating may involve obtaining representations of the RIPs and comparing the representations to each other.

The representations of the RIPs may be signatures of the RIPs. Examples of signature generations are illustrated in US patent application publication serial number US2020311470A1 which is incorporated herein by reference. The signature may be a list of indexes.

The representations of the RIPs may be neural network generated features of the RIPs.

Step 130 may be followed by step 140 of determining, based on the inter-reference image similarities of at least some of the multiple reference images, the similarity mapping.

Step 140 may include determining which RIPs are comparable—and which corresponding patches of an image of an evaluated manufactured item are comparable (according to the similarity mapping)—for example during inference.

Corresponding may include located at the same location and generated at the same manner.

Comparable RIPs may be RIPs that are similar enough to each other—within at least a certain number of the RIPs or within a certain percent of the multiple reference images.

The similarity mapping may include one or more similarity rules that define locations of comparable patches and one or more RIP attributes. The RIP attributes may include the manner in which the comparison between patches should be applied, for example one or more transformation to be applied on one or more comparable patch during the comparison, and/or a required similarity range or threshold to be indicative of a lack of defect.

Examples of transformations may include rotation, inversion, and the like to be applied on one or more members of a set of comparable patches.

Non-limiting examples of similarity rules may include:
a. Compare a first patch of 3×3 pixels that is located at first location to a ninety degrees clockwise rotated second patch of 3×3 pixels that is located at a second location.
b. Compare a first triangular patch of 25 pixels that is located at first location to a second triangular patch of 25 pixels that is located at a second location, and to a third triangular patch of 25 pixels that is located at a third location, wherein the comparison includes calculating certain signatures of the first till third triangular patches and require that the similarity exceeds 90 percent.
c. Compare N1 patches of a certain size and shape and located at N1 different locations while applying N2 transformations, and apply a certain similarity test.

Step 140 may include defining a similarity rule only when the similarity rule is applicable to all of the multiple reference images.

Step 140 may include defining a similarity rule only when the similarity rule is applicable to the at least some of the multiple reference images. What amount to “at least some” may be determined in advance, may depend on the values of the inter-reference image similarities (for example—reducing the number of the at least some reference images with an increase of the inter-reference image similarities), may change over time, may be a fixed number, may be a certain percent of the multiple reference images, may be include an absolute number of reference images.

For example—assuming that there are K reference images—then a similarity rule may be defined if it is applicable (having the same comparable RIPs) at all K reference images, or at a certain percentage (J) of the K reference images, whereas J may be fixed or dependent on values of the inter-reference image similarities. K may range between 10 and 10,000 (or more) J may range between 50 and 99, and the like.

Step 140 may include assigning weights to the one or more similarity rules.

The assigning of the weights may be responsive to occurrences of the inter-reference image similarities represented by the one or more similarity rules.

A weight assigned to a similarity rule may represent the importance of the similarity rule to the estimate of whether there is a defect or not.

The one or more similarity rules may include locations of comparable patches and one or more transformations to be applied on the comparable patches. For example—a similarity rule may include comparing a first patch to a rotated second patch.

The similarity rule may also include a required similarity—for example—the similarity rule may indicate that there is a defect when comparable patches are not perfectly matching to each other—but may defined a certain level of similarity other than perfect match—that will be indicative of a non-defected item.

Step 140 may include storing the similarity mapping, transmitting the similarity mapping, and the like.

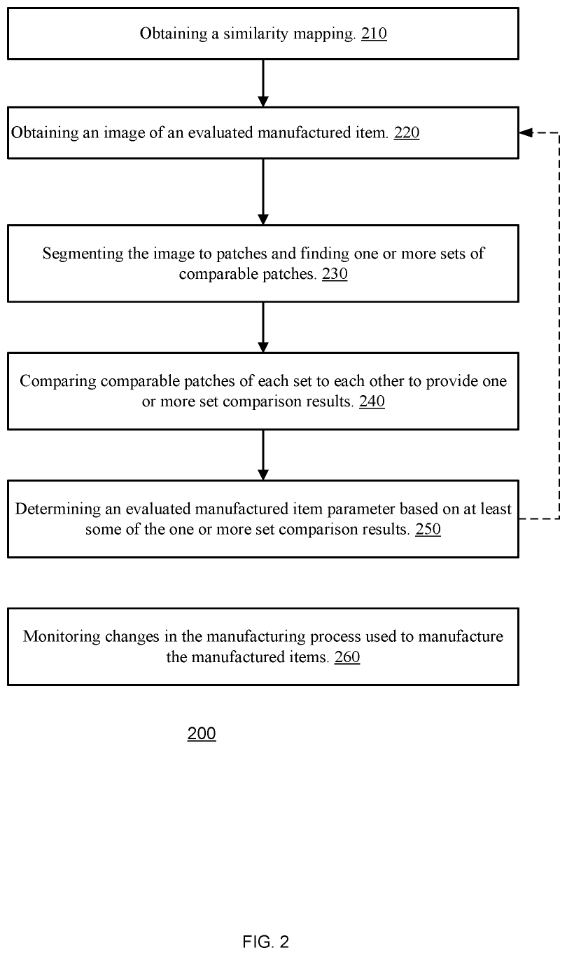

FIG. 2 illustrates an example of method 200 for detecting defects in manufactured items.

Method 200 is repeated for multiple evaluated manufactured items.

Method 200 may start by step 210 of obtaining a similarity mapping. The similarity mapping may be generated by method 100.

Step 210 may be followed by step 220 of obtaining an image of an evaluated manufactured item.

Step 220 may be followed by step 230 of segmenting the image to patches and finding one or more sets of comparable patches. Members of a set should be compared to each other.

The segmenting and the finding are based on a similarity mapping. The similarity mapping is generated based on inter-reference image similarities between patches of reference images. The similarity mapping defined which patches are comparable (and includes information about how to generate the patches) and may also indicate how the comparison should be made, which transformation to apply, and the like.

Step 230 may be followed by step 240 of comparing comparable patches of each set to each other to provide one or more set comparison results.

Step 240 may be followed by step 250 of determining an evaluated manufactured item parameter based on at least some of the one or more set comparison results.

Examples of determinations:
a. Determine that the evaluated manufactured item is OK only when all comparison rules regarding the evaluated manufactured item are fulfilled.
b. Determine that the evaluated manufactured item is OK when at least X1 percent of all comparison rules regarding the evaluated manufactured item are fulfilled.
c. Determine that there is a Y1 probability that the evaluated manufactured item is OK when Z1 percent of all comparison rules regarding the evaluated manufactured item are fulfilled
d. Determine that the evaluated manufactured item is OK when an aggregate weight (W) of the fulfilled comparison rules regarding the evaluated manufactured item exceeds an aggregate weight threshold.

The evaluated manufactured item parameter may indicate whether the evaluated manufactured is faulty or not, may include a level or degree or functionality of the evaluated manufactured item, may indicate whether there are one or more defects—and if so may provide information about the one or more defects (for example—location and/or size, and/or severity, one or more class of the one or more defect, suspected cause of the defect, and the like).

Step 250 may include checking which similarity rules are fulfilled (or not fulfilled). For example—a defect or a suspected defect can be declared if no similarity rule is fulfilled, is a number of similarity rules that are fulfilled does not exceed a predefined threshold, if an aggregate weights of fulfilled similarity rules does not exceed an aggregated weight threshold, if the relationship between fulfilled and unfulfilled similarity rules does not comply with a predefined requirement, and the like.

Step 250 may include storing the an evaluated manufactured item parameter, transmitting the an evaluated manufactured item parameter, sending alerts or notifications regarding the evaluated manufactured item parameter, and the like.

Method 200 may also include step 260 of monitoring changes in the manufacturing process used to manufacture the manufactured items.

The monitoring may include multiple comparison iterations that involve checking changes, over time (for example between iteration to another), of one or more inter-reference image similarities. The inter-reference image similarities may be calculated between comparable patches and/or between non-comparable patches.

One or more monitoring rules may be applied to define which changes are indicative of a non-tolerable (may be defined in any manner—for example by the manufacturer of the items, by a client, and the like) change in the manufacturing process.

Step 260 may also include providing alerts, indication, regarding changes within the manufacturing process.

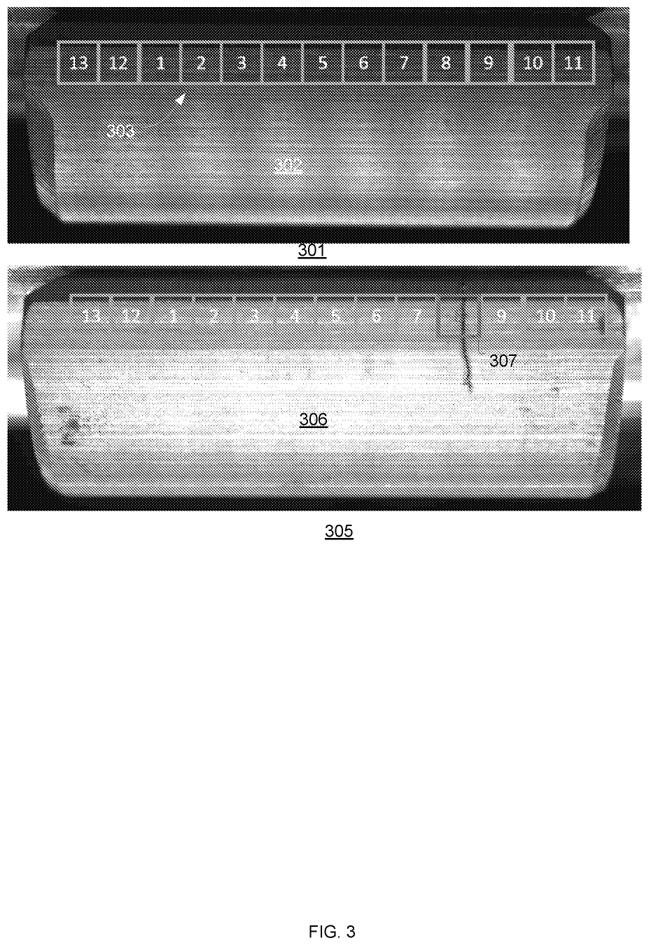

FIG. 3 illustrates an image 301 of a reference item 302 and a similarity rule that requires that thirteen patches 303 (denoted 1-13) are similar to each other.

FIG. 3 also illustrated an image 305 of an evaluated manufactured item 306 and an applying of the similarity rule—that is indicative of a fault 307—as the eighth patch differs from other twelve patches.

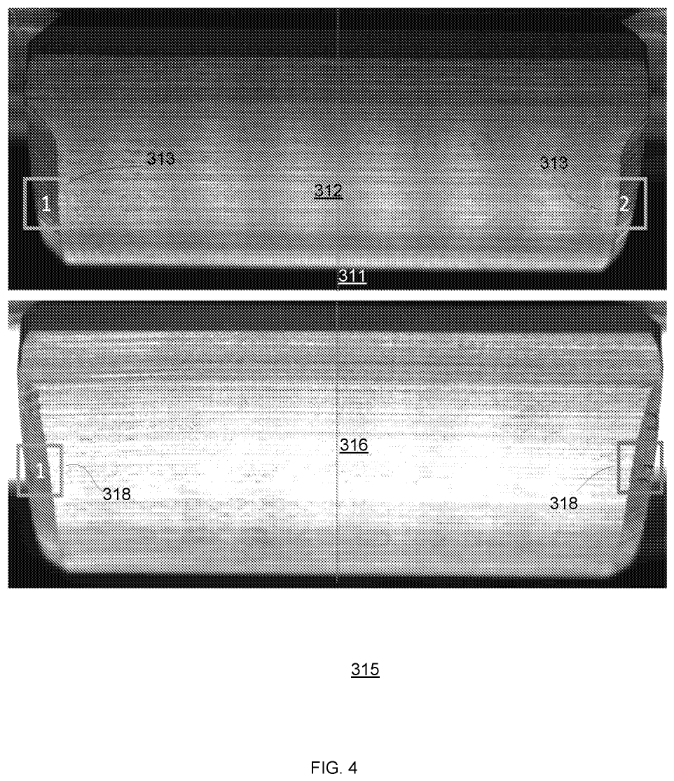

FIG. 4 illustrates an image 311 of a reference item 312 and a similarity rule that requires that two patches 313 (denoted 1 and 2) are similar to each other.

FIG. 4 also illustrated an image 315 of an evaluated manufactured item 316 and an applying of the similarity rule—that is indicative of a non-faulty evaluated manufactured item—as the two patches 318 match each other (after applying a mirror transformation on one of the patches.

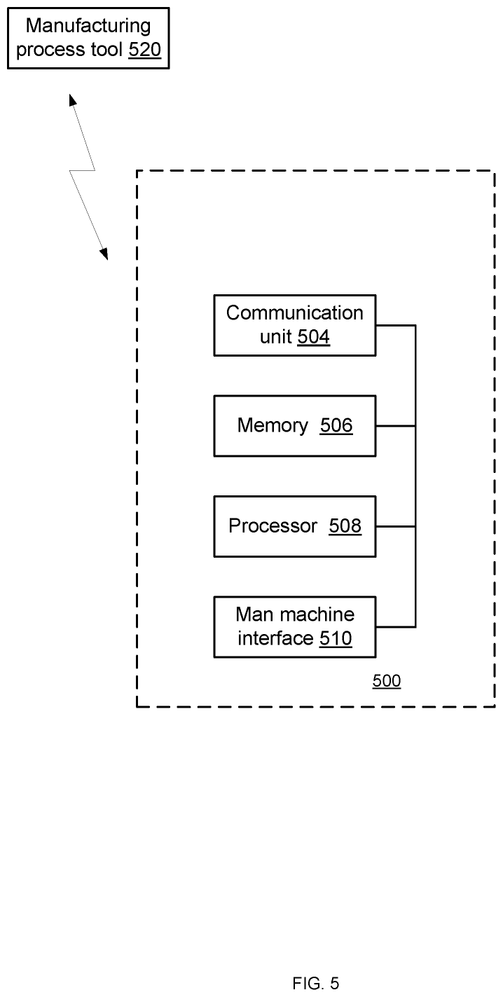

FIG. 5 illustrates an example of a computerized system 500 and a manufacturing process tool 520.

The computerized system 500 may execute method 100 and/or method 200.

The computerized system 500 may or may not communicate with the manufacturing process tool 520—for example to provide feedback about the manufacturing process applied by the manufacturing process tool 520 (that manufactured the evaluated manufactured items) and/or for receiving images of the evaluated manufactured items, and the like. The computerized system 500 may be included in the manufacturing process tool 520.

The computerized system 500 may include a communication unit 504, memory 506, processor 508 and may optionally include a man machine interface 510.

The invention may also be implemented in a computer program for running on a computer system, at least including code portions for performing steps of a method according to the invention when run on a programmable apparatus, such as a computer system or enabling a programmable apparatus to perform functions of a device or system according to the invention. The computer program may cause the storage system to allocate disk drives to disk drive groups.

A computer program is a list of instructions such as a particular application program and/or an operating system. The computer program may for instance include one or more of: a subroutine, a function, a procedure, an object method, an object implementation, an executable application, an applet, a servlet, a source code, an object code, a shared library/dynamic load library and/or other sequence of instructions designed for execution on a computer system.

The computer program may be stored internally on a non-transitory computer readable medium. All or some of the computer program may be provided on computer readable media permanently, removably or remotely coupled to an information processing system. The computer readable media may include, for example and without limitation, any number of the following: magnetic storage media including disk and tape storage media; optical storage media such as compact disk media (e.g., CD-ROM, CD-R, etc.) and digital video disk storage media; nonvolatile memory storage media including semiconductor-based memory units such as flash memory, EEPROM, EPROM, ROM; ferromagnetic digital memories; MRAM; volatile storage media including registers, buffers or caches, main memory, RAM, etc.

A computer process typically includes an executing (running) program or portion of a program, current program values and state information, and the resources used by the operating system to manage the execution of the process. An operating system (OS) is the software that manages the sharing of the resources of a computer and provides programmers with an interface used to access those resources. An operating system processes system data and user input, and responds by allocating and managing tasks and internal system resources as a service to users and programs of the system.

The computer system may for instance include at least one processing unit, associated memory and a number of input/output (I/O) devices. When executing the computer program, the computer system processes information according to the computer program and produces resultant output information via I/O devices.

In the foregoing specification, the invention has been described with reference to specific examples of embodiments of the invention. It will, however, be evident that various modifications and changes may be made therein without departing from the broader spirit and scope of the invention as set forth in the appended claims.

Moreover, the terms “front,” “back,” “top,” “bottom,” “over,” “under” and the like in the description and in the claims, if any, are used for descriptive purposes and not necessarily for describing permanent relative positions. It is understood that the terms so used are interchangeable under appropriate circumstances such that the embodiments of the invention described herein are, for example, capable of operation in other orientations than those illustrated or otherwise described herein.

The connections as discussed herein may be any type of connection suitable to transfer signals from or to the respective nodes, units or devices, for example via intermediate devices. Accordingly, unless implied or stated otherwise, the connections may for example be direct connections or indirect connections. The connections may be illustrated or described in reference to being a single connection, a plurality of connections, unidirectional connections, or bidirectional connections. However, different embodiments may vary the implementation of the connections. For example, separate unidirectional connections may be used rather than bidirectional connections and vice versa. Also, plurality of connections may be replaced with a single connection that transfers multiple signals serially or in a time multiplexed manner. Likewise, single connections carrying multiple signals may be separated out into various different connections carrying subsets of these signals. Therefore, many options exist for transferring signals.

Although specific conductivity types or polarity of potentials have been described in the examples, it will be appreciated that conductivity types and polarities of potentials may be reversed.

Each signal described herein may be designed as positive or negative logic. In the case of a negative logic signal, the signal is active low where the logically true state corresponds to a logic level zero. In the case of a positive logic signal, the signal is active high where the logically true state corresponds to a logic level one. Note that any of the signals described herein may be designed as either negative or positive logic signals. Therefore, in alternate embodiments, those signals described as positive logic signals may be implemented as negative logic signals, and those signals described as negative logic signals may be implemented as positive logic signals.

Furthermore, the terms “assert” or “set” and “negate” (or “deassert” or “clear”) are used herein when referring to the rendering of a signal, status bit, or similar apparatus into its logically true or logically false state, respectively. If the logically true state is a logic level one, the logically false state is a logic level zero. And if the logically true state is a logic level zero, the logically false state is a logic level one.

Those skilled in the art will recognize that the boundaries between logic blocks are merely illustrative and that alternative embodiments may merge logic blocks or circuit elements or impose an alternate decomposition of functionality upon various logic blocks or circuit elements. Thus, it is to be understood that the architectures depicted herein are merely exemplary, and that in fact many other architectures may be implemented which achieve the same functionality.

Any arrangement of components to achieve the same functionality is effectively “associated” such that the desired functionality is achieved. Hence, any two components herein combined to achieve a particular functionality may be seen as “associated with” each other such that the desired functionality is achieved, irrespective of architectures or intermedial components. Likewise, any two components so associated can also be viewed as being “operably connected,” or “operably coupled,” to each other to achieve the desired functionality.

Furthermore, those skilled in the art will recognize that boundaries between the above described operations merely illustrative. The multiple operations may be combined into a single operation, a single operation may be distributed in additional operations and operations may be executed at least partially overlapping in time. Moreover, alternative embodiments may include multiple instances of a particular operation, and the order of operations may be altered in various other embodiments.

Also for example, in one embodiment, the illustrated examples may be implemented as circuitry located on a single integrated circuit or within a same device. Alternatively, the examples may be implemented as any number of separate integrated circuits or separate devices interconnected with each other in a suitable manner.

Also for example, the examples, or portions thereof, may implemented as soft or code representations of physical circuitry or of logical representations convertible into physical circuitry, such as in a hardware description language of any appropriate type.

Also, the invention is not limited to physical devices or units implemented in non-programmable hardware but can also be applied in programmable devices or units able to perform the desired device functions by operating in accordance with suitable program code, such as mainframes, minicomputers, servers, workstations, personal computers, notepads, personal digital assistants, electronic games, automotive and other embedded systems, cell phones and various other wireless devices, commonly denoted in this application as ‘computer systems’.

However, other modifications, variations and alternatives are also possible. The specifications and drawings are, accordingly, to be regarded in an illustrative rather than in a restrictive sense.

In the claims, any reference signs placed between parentheses shall not be construed as limiting the claim. The word ‘comprising’ does not exclude the presence of other elements or steps then those listed in a claim. Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles. Unless stated otherwise, terms such as “first” and “second” are used to arbitrarily distinguish between the elements such terms describe. Thus, these terms are not necessarily intended to indicate temporal or other prioritization of such elements. The mere fact that certain measures are recited in mutually different claims does not indicate that a combination of these measures cannot be used to advantage.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

We claim:

1. A method for detecting defects in manufactured items, the method comprises:
obtaining an image of an evaluated manufactured item;
finding one or more sets of comparable patches; wherein the finding is based on a similarity mapping that is generated based on inter-reference image similarities between patches of reference images;
comparing comparable patches of each set to each other to provide one or more set comparison results; and
determining an evaluated manufactured item parameter based on at least some of the one or more set comparison results.

2. The method according to claim 1 wherein the similarity mapping is generated by:
segmenting each reference image to provide different groups of reference image patches (RIPs), wherein evaluated RIPs of the different groups of evaluated RIPs differ from each other by one or more RIP attribute;
calculating, for each reference image, inter-reference image similarities between RIPs of the different groups; and
determining, based on the inter-reference image similarities of at least some of the reference images, the similarity mapping.

3. The method according to claim 2 wherein the similarity mapping comprises one or more similarity rules that define locations of comparable patches and a one or more RIP attributes.

4. The method according to claim 3 comprising defining a similarity rule only when the similarity rule is applicable to all of the reference images.

5. The method according to claim 3 comprising defining a similarity rule only when the similarity rule is applicable to the at least some of the reference images.

6. The method according to claim 3 comprising assigning weights to the one or more similarity rules.

7. The method according to claim 6 wherein assigning of the weights is responsive to occurrences of the inter-reference image similarities represented by the one or more similarity rules.

8. The method according to claim 3 wherein the one or more similarity rules comprises one or more transformations.

9. The method according to claim 2 wherein the calculating of the inter-reference image similarities between RIPs comprises obtaining representations of the RIPs and comparing the representations to each other.

10. The method according to claim 9 wherein the representations of the RIPs are signatures of the RIPs.

11. The method according to claim 9 wherein the representations of the RIPs are neural network generated features of the RIPs.

12. The method according to claim 1 wherein the similarity mapping is indicative of inter-reference image matches.

13. The method according to claim 1 wherein the similarity mapping is generated based on images of non-defective instances of the item.

14. The method according to claim 1 comprising monitoring after changes in a manufacturing process used to manufacture the manufactured items.

15. The method according to claim 1 comprises calculating inter-reference image similarities between patches of evaluated manufactured item, wherein the patches comprises comparable patches and non-comparable patches.

16. The method according to claim 15 comprising searching for changes over time of values of at least some of the inter-reference image similarities.
